(19) United States
(12) Patent Application Publication
(10) Pub. No.: US 2019/0067653 A1
(43) Pub. Date: Feb. 28, 2019

(54) CHAMBER SEAL FOR A POWER CELL

(71) Applicant: Parker-Hannifin Corporation, Cleveland, OH (US)

(72) Inventor: Mason D. Morehead, Signal Mountain, TN (US)

(21) Appl. No.: 16/051,700

(22) Filed: Aug. 1, 2018

Related U.S. Application Data
(60) Provisional application No. 62/549,144, filed on Aug. 23, 2017.

(51) Int. Cl. H01M 2/08; H01M 2/04; H01M 8/0273; H01M 8/0276; H01M 8/028

(52) U.S. Cl. CPC H01M 2/08; H01M 2/0404; H01M 8/028; H01M 8/0276; H01M 8/0273

(57) ABSTRACT

An annular seal assembly, to seal a chamber of a power cell, includes opposed mating members, a separation plate covering an opening of one of the mating members, and an annular seal for sealing about the separation plate and between the separation plate and each of the adjacent mating members. An exemplary annular seal includes a seal body that is disposed about a longitudinal axis and is configured to receive an outer perimeter edge of the separation plate into a slit of the seal body. The seal in an uncompressed state isolated from the separation plate and the mating members includes opposed axial faces of the slit being biased towards one another. The seal includes bulbous sealing projections disposed at opposite axial sides of the slit that are compressible to seal between the separation plate and the mating members.

### RELATED APPLICATIONS

This application claims the benefit of U.S. Provisional Application No. 62/549,144 filed Aug. 23, 2017, which is incorporated herein by reference.

### FIELD OF INVENTION

The present invention relates generally to elastomeric seals, and more particularly to an elastomeric seal for use in sealing a chamber of a power cell.

### BACKGROUND

An annular seal is a continuous thermosetting or thermoplastic rubber device that prevents leakage. A common configuration of annular seal is an O-ring seal having a circular circumference and a circular cross-section. Other annular seals may have a non-circular circumference and/or a non-circular cross-section having the shape of a square, rectangle, trapezoid, or X-shape, for example. Particular circumference and cross-sectional shapes are intended to provide a specific sealing performance advantage in a particular application. Some cross-sectional shapes may include portions that are not intended to perform a sealing function, but rather serve to connect sealing portions to a seal retainer or comparable structure.

Annular seals may be used to seal between or around surfaces. Other annular seals may include a slit or a channel for receiving a portion of a device around which a seal is needed. An annular seal may be used is to seal between two environments. For example, a device may include a section having a liquid-filled cavity and a section having a gas-filled cavity, and an annular seal may be used to seal between walls defining the respective cavities. One such example may be an annular seal used to seal one or more chambers of a power cell.

A typical large power cell is often separated into chambers containing liquid that crates a charge. The chambers can be separated by plates sandwiched between frames, and a seal is provided between the plate and each adjacent frame. An annular seal can be used in such a situation.

### SUMMARY OF INVENTION

The present invention provides an annular seal assembly to seal a chamber of a chambered device, such as a power cell. In an exemplary embodiment, the seal assembly includes opposed retainer members, a separation plate covering an opening of one of the retainer members, and an annular seal for sealing about the separation plate and between the separation plate and each of the adjacent retainer members. For example, an exemplary seal assembly for sealing between and defining adjacent chambers of a power cell may include opposed frame members, a separation plate for covering the central opening of each of the adjacent frame members, and an annular seal wrapped about the separation plate to seal between the separation plate and the frame members.

An exemplary annular seal includes a seal body disposed about a longitudinal axis and that is configured to receive an outer perimeter edge of the separation plate into a slit of the seal body. The seal includes opposed axial walls of the slit being biased towards one another and bulbous sealing projections disposed at opposite axial sides of the slit that are compressible to seal between the separation plate and the mating members.

According to one aspect of the invention, an annular seal includes an annular seal body formed of an elastomeric material and configured for being compressed along a longitudinal axis of the seal body. The seal body has a slit that opens radially inwardly towards the longitudinal axis and into a central opening through the seal. The slit extends about the central opening. The seal body also has a pair of opposed longitudinally facing sealing projections disposed at opposite sides of the seal body across the slit and extending about the central opening for being compressed when located within a seal retainer. A U-shaped connecting portion is located radially outwardly of the longitudinally facing sealing projections and defines an internal cavity extending about the longitudinal axis. The slit extends radially outwardly of the longitudinally facing sealing projections to the internal cavity.

The longitudinally facing sealing projections each may have a rounded, bulbous shape extending longitudinally in opposite directions parallel to the longitudinal axis.

The U-shaped connecting portion may have a longitudinally facing upper face and a longitudinally facing lower face disposed opposite one another and extending parallel to one another.

The U-shaped connecting portion may have longitudinally facing upper and lower faces that extend radially outwardly from the pair of opposed longitudinally facing sealing projections in a direction orthogonal to the longitudinal axis.

The longitudinally facing sealing projections each may be spaced a same distance radially inwardly from a radially outermost extent of the seal body.

The seal body may have a U-shaped cross-section taken in a direction from the longitudinal axis radially outwardly to a radially outermost extent of the seal body.

The seal body may include a pair of radially inwardly extending legs defining the slit therebetween.

The slit may extend radially into the seal body to an internal cavity extending about the longitudinal axis within the seal body and disposed radially outward of the longitudinally facing sealing projections.

The slit may extend radially outwardly along a lateral plane disposed orthogonal to the longitudinal axis of the seal body.

The seal body may include longitudinally opposed beveled ends angled radially inwardly towards one another to define an opening for the slit.

The slit may separate the seal body into a longitudinally-upper portion and a longitudinally-lower portion that are radially outwardly connected to one another at a U-shaped connecting portion.

The seal body may be configured such that the seal body is biased towards a closed position of the slit when the seal is isolated in an uncompressed state.

The seal may be a static seal.

The sealing assembly may further include a separation plate, wherein an outer perimeter edge of the separation plate is received into the slit such that the annular seal is disposed fully about the outer perimeter edge of the separation plate.

According to another aspect of the invention, an annular seal, for sealing about a separation plate disposed between mating members of chambers of a chambered device, includes a seal body having a longitudinal axis and extending annularly about the longitudinal axis and about a central opening of the seal body. The seal body includes a pair of opposed legs extending radially inwardly toward the central opening, and a pair of bulbous sealing projections longitudinally projecting in opposite directions from a respective leg of the pair of opposed legs for contact with respective opposed mating members of the chambered device. A U-shaped connecting portion connects radially outward extents of the pair of opposed legs. The connecting portion defines therein an annular cavity extending about the longitudinal axis and disposed radially outwardly of the sealing projections. The seal body extends radially along a radial length between the radially-outwardly located U-shaped connecting portion and radially-inwardly projecting distal ends of the pair of opposed legs. The legs are longitudinally separable from one another across the radial length for receipt of the separation plate therebetween into the seal body.

The pair of bulbous sealing portions may be offset radially inwardly from a midpoint along the radial extent.

Each leg of the pair of opposed legs may include a longitudinally-inwardly directed face, and the seal isolated in an uncompressed state may include the legs biased longitudinally inwardly towards one another.

The internal cavity may have a longitudinally upper wall of the cavity and a longitudinally lower wall of the cavity, where the seal body may be configured to maintain separation of the upper wall and the lower wall from one another when the seal is in a compressed state.

The annular seal may be in combination with the separation plate, wherein an outer perimeter edge of the separation plate is received into the slit such that the annular seal is disposed fully about the outer perimeter edge of the separation plate.

According to yet another aspect of the invention, a chambered power cell, includes a power cell body and a seal assembly disposed within the power cell body for sealing between adjacent chambers of the power cell. The seal assembly includes opposed retainer members each having an opening, a separation plate disposed between the opposed retainer members and covering the openings of the retainer members, and an annular seal retained in opposed cavities of the opposed retainer members. The seal has a U-shaped cross-section and a seal body disposed about a longitudinal axis that is configured to receive an outer perimeter edge of the separation plate into a slit of the seal body such that the seal is disposed fully about the separation plate. The seal includes opposed axial walls of the slit being biased towards one another, and a pair of opposed, bulbous sealing projections disposed at opposite axial sides of the slit and being compressible to seal between the separation plate and each of the opposed frame members of the power cell to separate environments of the adjacent chambers of the power cell from one another.

The annular seal may include a radially-inwardly angled lead-in at a radially innermost extent of the seal to receive the separation plate therebetween.

The slit of the annular seal may extend radially outwardly to an annular cavity disposed within the seal radially outwardly of the bulbous sealing projections.

The foregoing and other features of the invention are hereinafter fully described and particularly pointed out in the claims, the following description and annexed drawings setting forth in detail certain illustrative embodiments of the invention, these embodiments being indicative, however, of but a few of the various ways in which the principles of the invention may be employed.

### BRIEF DESCRIPTION OF THE DRAWINGS

The annexed drawings, which are not necessarily to scale, show various aspects of the disclosure.

FIG. 1 is a cross-sectional view of a portion of an exemplary seal assembly in accordance with the present invention, including a separation plate, opposed mating members, and an exemplary seal also in accordance with the present invention.

FIG. 2 is a view of a power cell including the exemplary seal assembly of FIG. 1.

FIG. 3 is a top elevated exploded view showing the separation plate and the seal of FIG. 1 separated from one another.

FIG. 4 is an orthogonal view of the separation plate and the seal of FIG. 1 shown in cross-section in an assembled state.

FIG. 5 is a cross-sectional view of the exemplary seal of FIG. 3, with the cross-section taken across a diameter of the seal through line 5-5 of FIG. 3.

FIG. 6 is a partial cross-sectional view of the exemplary seal of FIG. 1, with the cross-section taken along a radial length of the seal and taken through the line 6-6 of FIG. 3.

FIG. 7 is a partial cross-sectional view of another exemplary seal according to the present invention.

FIG. 8 is partial cross-sectional view of another seal assembly in accordance with the present invention.

### DETAILED DESCRIPTION

The principles of the present disclosure have general application to a seal assembly for sealing a chamber of a chambered device, and particular application to a seal assembly for sealing a chamber of a power cell. The power cell may have one or more adjacent chambers requiring sealing, such as to maintain separate environments in the chamber(s) from one another and/or with respect to an environment external to the chamber(s). For example, sealing may be necessary between two adjacent chambers or between one chamber and a power cell body or an environment external to the power cell. The separation may be necessary to enable a reaction to take place between the chambers. The power cell may be an electric cell such as an electric battery, an electrochemical cell, an electro-biochemical cell, or a fuel cell, for example. The principles also are applicable to a seal assembly for sealing one or more chambers of any device having need for maintaining isolation of an environment in the one or more chambers.

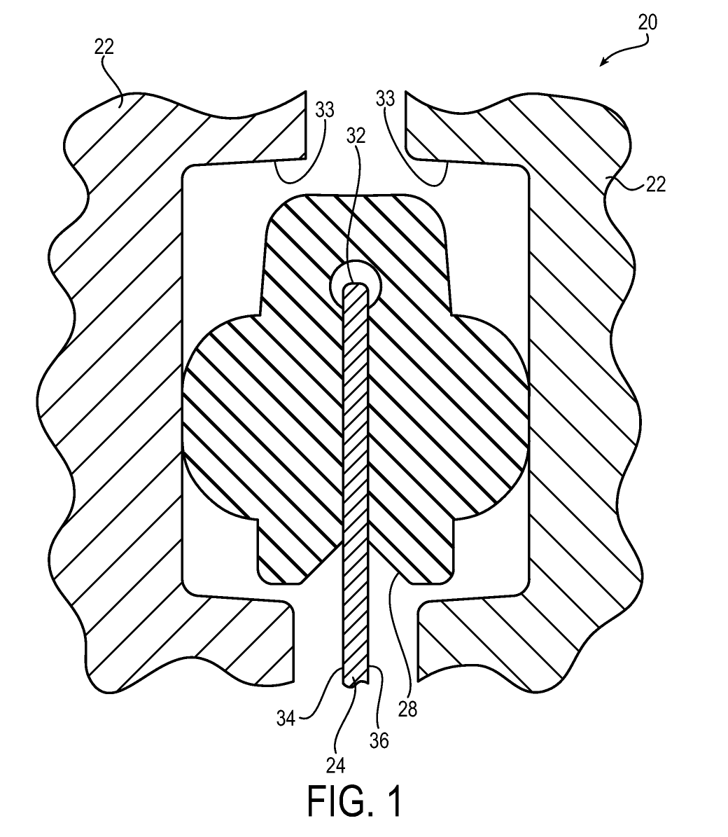

Turning first to FIGS. 1 to 3, an exemplary seal assembly 20 is illustrated to seal a chamber of a power cell 10, such as to seal between adjacent chambers 12 and 14 defined in a power cell body 16 of the power cell 10. The power cell 10 may be configured to contain a reactant liquid in each of the chambers 12 and 14 where a charge may be created between the chambers 12 and 14 across a separation plate 24 disposed between the chambers 12 and 14.

The seal assembly 20 includes adjacent mating members 22, also herein referred to as retainer members 22 or frame members 22, the separation plate 24 for sealing between the mating members 22, and an annular seal 28 to seal about the separation plate 24 and between the separation plate 24 and each of the opposed mating members 22. The depicted frame members 22 are each retained in the power cell body 16. Each frame member 22 has an opening 30, such as a centrally-located opening. The separation plate 24 is provided for disposition between the frame members 22 to cover the openings 30. The separation plate 24, frame members 22, and power cell body 16 may therefore define the adjacent chambers 12 and 14. The separation plate 24 may be made of any suitable material for creation of the charge across the plate 24, such as titanium.

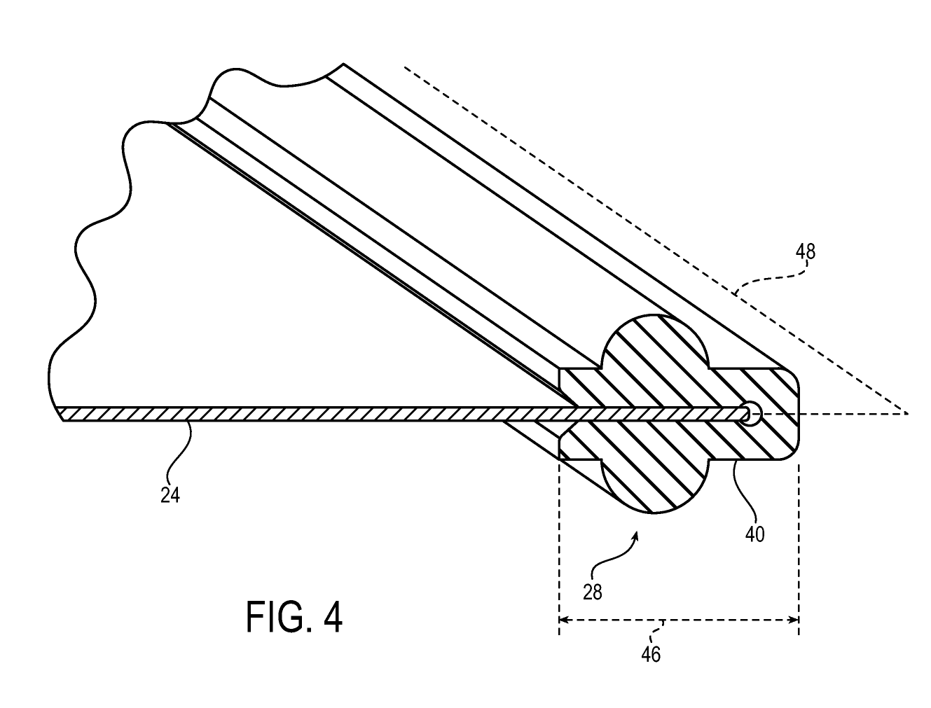

Turning now to FIG. 4 in addition to FIGS. 1 to 3, to restrict or altogether prevent leakage of reactants between the chambers, the annular seal 28 is provided. The annular seal 28 is configured to receive an outer perimeter edge 32 of the separation plate 24, such that the annular seal 28 is disposed fully about the perimeter of the separation plate 24. The annular seal 28 further is configured to seal between the frame members 22 and the separation plate 24, such as between the frame members 24 and outer perimeter portions at opposite axial sides 34, 36 of the separation plate 24.

The frame members 22 each define a cavity, such as a channel 33, shaped to receive at least a portion of the annular seal 28. When the frame members 22 are brought towards one another, the annular seal 28 may be placed into a compressed state sandwiched between each of the opposite axial sides 34, 36 of the separation plate 24 and the respective adjacent frame members 22. In this way, the seal 28 is configured to be a static seal.

The seal 28 is formed from an elastomeric material, such as preferably an elastomeric polymeric material. Potential elastomeric materials include a thermosetting elastomer, a thermoplastic elastomer, fluorosilicone, fluorocarbon, acrylonitrile-butadiene rubber, hydrogenated acrylonitrile-butadiene rubber, carboxylated acrylonitrile-butadiene rubber, butadiene rubber, styrene-butadiene rubber, isobutylene-isoprene rubber, halogenated isobutylene-isoprene rubber, polychloroprene rubber, synthetic polyisoprene rubber, natural rubber, polyacrylate rubber, ethylene-acrylate rubber, ethylene-propylene rubber, ethylene-propylene-diene rubber, fluorinated silicone rubber, silicone rubber, thermosetting polyurethane rubber, fluorocarbon rubber comprising at least two of vinylidene fluoride, hexafluoropropylene, tetrafluoroethylene, perfluoro methyl vinyl ether, and a monomer, tetrafluoroethylene-propylene rubber, perfluoroelastomer rubber, thermoplastic polyurethane rubber, styrenic block copolymer thermoplastic rubber, polyolefin thermoplastic rubber, thermoplastic copolyester rubber, and thermoplastic polyamide rubber.

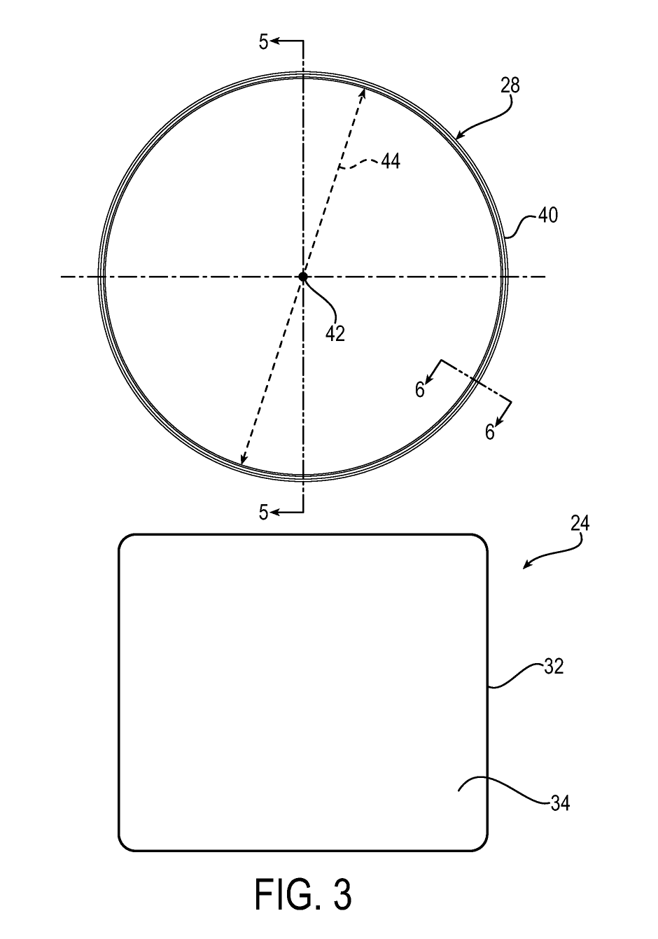

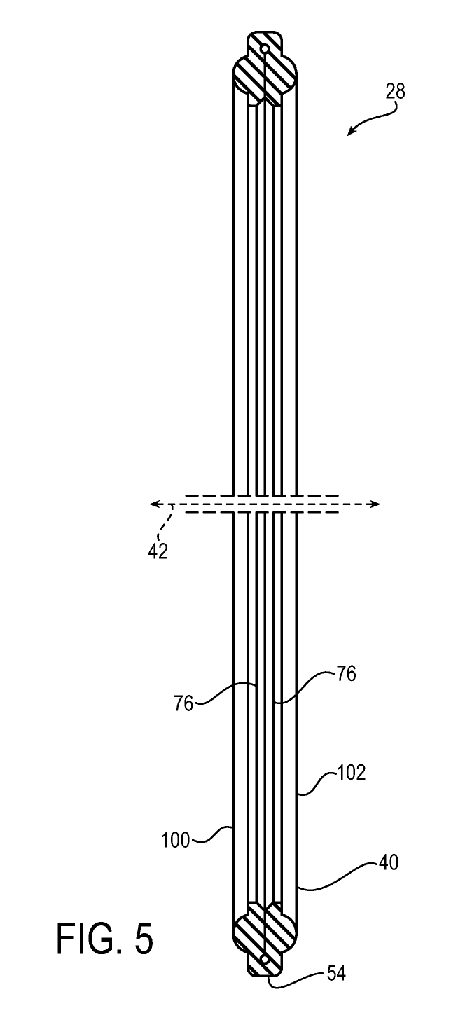

Referring now to FIGS. 3 to 6, the depicted annular seal 28 includes a seal body 40 that is configured for being compressed along a longitudinal axis 42 (FIG. 3) of the seal body 40. A central opening 44 (FIG. 3) extends through the seal body 40 along the longitudinal axis 42. The seal body 40 extends annularly about the longitudinal axis 42 and may have a circular shape prior to receipt of the separation plate 24.

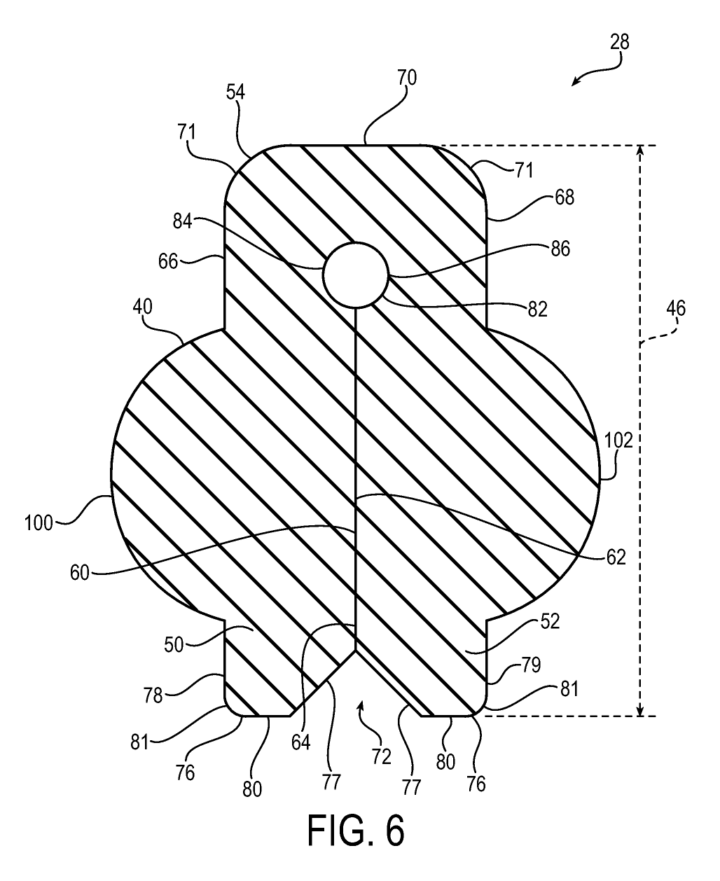

The seal body 40 is shown in cross-section in FIG. 6, taken across a lateral length 46 (also referred to as a radial length or radial extent) of the seal body 40. The lateral length 46 generally extends along a lateral plane 48 (FIG. 4) of the seal body 40 that is disposed orthogonal to the central longitudinal axis 42. The lateral length 46 extends between a radially innermost extent, at least partially defining the central opening 44, and a radially outermost extent, defining an outer circumference of the seal body 40. The seal body 40 in this cross-section has a U-shape for receiving the separation plate 24 in the U-shape.

The U-shape is defined by a pair of legs 50, 52 extending radially inwardly towards the central opening 44. The legs include a longitudinally upper leg 50 and an opposed longitudinally lower leg 52 that each extend about the longitudinal axis 42, such as circumferentially about the longitudinal axis 42. Radially innermost extents of the legs 50, 52 define the central opening 44, while radially outermost extents of the legs 50, 52 are connected at a U-shaped connecting portion 54 that defines the outer perimeter of the seal body 40. It will be appreciated that upper and lower designations are merely reference designations and the seal 28 may oriented is any suitable configuration as desirable for a particular application.

The legs 50, 52 are longitudinally separable from one another in a direction along the longitudinal axis 42. The separation is enabled across a radially inner section of the lateral length 46 to allow the receipt of the separation plate 24 into the seal body 40. The longitudinally upper leg 50 has a wall having a longitudinally-inwardly directed face 60, and the longitudinally lower leg 52 has a wall having a longitudinally-inwardly directed face 62 that define therebetween a slit 64 for receiving the separation plate 24. The slit 64 separates the body 40 into a longitudinally-upper portion and a longitudinally-lower portion that are radially outwardly connected to one another at the connecting portion 54.

The U-shaped connecting portion 54 has a longitudinally facing upper face 66 and a longitudinally facing lower face 68 disposed opposite one another, such as axially opposite one another across the slit 64. The illustrated faces 66, 68 extend parallel to one another. A radially outer face 70 of the U-shaped connection portion 54 defines the outermost extent of the seal body 40. The illustrated outer face 70 extends parallel the longitudinal axis 42. A rounded edge 71 is disposed between and connects the longitudinally facing upper face 66 and the radially outer face 70. Another rounded edge 71 is disposed between and connects the longitudinally facing lower face 68 and the radially outer face 70.

The slit 64 is disposed radially inward of the radially outer face 70 and extends about the central opening 44, such as fully about the central opening 44. The slit 64 also extends generally along the lateral plane 48 and opens radially inwardly towards the longitudinal axis 42 and to the central opening 44. In other embodiments, the slit 64 may not extend along the lateral plane 48.

At the opening 72 of the slit 64, the legs 50 and 52 included end portions 76. The end portions 76 have axially inner faces 77 that are angled radially inwardly towards one another and towards the lateral plane 48. In this way, the end portions 76 define an angled lead-in. The lead-in enables ease of receipt of the separation plate 24 into the slit 64 and wrapping of the seal 28 about the outer perimeter edge 32 of the plate 24.

The axially upper end portion 76 has a longitudinally facing upper face 78 and the axially lower end portion 76 has a longitudinally facing lower face 79 that are disposed opposite one another, such as axially opposite one another across the slit 64. The illustrated faces 78, 79 extend parallel to one another. A radially inner face 80 of each of the end portions 76 together define the innermost extent of the seal body 40. The illustrated inner faces 80 extend parallel the longitudinal axis 42. A rounded edge 81 is disposed between and connects the longitudinally facing upper face 78 and the radially inner face 80 of the upper end portion 76. Another rounded edge 81 is disposed between and connects the longitudinally facing lower face 79 and the radially inner face 80 of the lower end portion 76.

Radially opposite the end portions 76 along the lateral length 46, a radially outermost end of the slit 64 concludes at an annular cavity 82 defined by inner walls of the U-shaped connecting portion 54. The annular cavity 82 extends about the longitudinal axis 42 within the seal body 40, such as fully about the longitudinal axis 42 as depicted. The illustrated cavity 82 has a circular cross-section, though other cross-sectional shapes may be suitable in other embodiments. In other embodiments, the cavity 82 may extend less than fully about the longitudinal axis 42 and thus may not be a continuous annular cavity.

The annular cavity 82 is located along the lateral length 46 at a location between the longitudinally upper face 66 and the longitudinally lower face 68 of the U-shaped connecting portion 54. The annular cavity 82 has an axial height, extending along the longitudinal axis 42 and between the longitudinally upper and lower faces 66, 68, that is greater than an axial height (at the opening 72 of the slit 64, also extending along the longitudinal axis 42, when the seal 28 is in an uncompressed state.

The cavity 82 is defined by a longitudinally upper wall 84 of the cavity 82 and a longitudinally lower wall 86 of the cavity 82. The seal body 40 is configured, such as via its shape, to maintain separation of the upper wall 84 and the lower wall 86 from one another when the seal 28 is in a compressed state. The cavity 82 aids in spreading compressive forces acting on the legs 50, 52 at the outermost extent of the slit 64 to restrict or prevent tearing of the connecting portion 54 during the compression of the seal 28.

Absent compression of the seal 28, and isolated from the separation plate 24 and the frame members 22, the seal body 40 is configured such that the seal body 40 is biased in a position closing the slit 64 at the slit opening 72. In this isolated state of the seal 28 (and of the seal body 40), the legs 50, 52 are biased longitudinally inwardly towards one another, and towards the lateral plane 48. Accordingly, as depicted, the longitudinally-inwardly directed face 60 and the longitudinally-inwardly directed face 62 are in contact with one another in the isolated state.

The illustrated seal 28 is configured to be compressed along the longitudinal axis 42 between axially opposite sealing projections 100 and 102. The pair of opposed sealing projections 100 and 102 face in opposite longitudinal directions and are disposed at opposite axial sides of the seal body 40 across the slit 64. The compressible sealing projections 100, 102 are generally rounded, such as having a bulbous shape in cross-section taken along the lateral length 46. The depicted projections 100, 102 are of the same size. In other embodiments, the sealing projections may be otherwise shaped and/or sized, and/or there may be more than one sealing projection at one or both axial sides of the seal body 40.

Each projection 100, 102 is spaced a same distance radially inwardly along the lateral length 46 from a radially outermost extent of the seal body 40, such that the projections 100, 102 are radially aligned with one another. The projections 100 and 102 are disposed radially inward of the U-shaped connection portion 54. For example, the depicted projections 100, 102 are offset radially inwardly from a midpoint along the lateral length 46 and are disposed radially inward of the annular cavity 82. For example, the radially innermost extent of the annular cavity 82 is at most even with, or spaced from, the radially outer most extent of each of the projections 100, 102 along the lateral length 46. Other locations of one or more of the projections 100, 102 along the lateral length 46 may be suitable in other embodiments.

As illustrated, the longitudinally facing upper and lower faces 78, 79 of the end portions 76 extend radially inwardly from the pair of opposed longitudinally facing sealing projections 100, 102, such as in a direction orthogonal to the longitudinal axis 42. Likewise, the illustrated longitudinally facing upper and lower faces 66, 68 of the U-shaped connecting portion 54 extend radially outwardly from the pair of opposed longitudinally facing sealing projections 100, 102, such as in a direction orthogonal to the longitudinal axis 42. The illustrated upper faces 66, 78 are coplanar with one another in a plane parallel to the lateral plane 48. Likewise, the illustrated lower faces 68, 79 are coplanar with one another in a plane parallel to the lateral plane 48. In other embodiments, the coplanar faces may not be in a plane parallel to the lateral plane 48. In additional or alternative embodiments, the faces may be non-coplanar.

The sealing projections 100 and 102 each extend about the central opening 44, such as fully circumferentially. The projections 100 and 102 may extend less than fully circumferentially or may include circumferentially separated sections in other embodiments. Use of the term circumferentially herein may denote a circular or other generally rounded shape.

The longitudinally upper sealing projection 100 extends longitudinally upwardly from the longitudinally upper leg 50 in a direction generally parallel to the longitudinal axis 42. The longitudinally lower sealing projection 102 extends longitudinally downwardly (in an opposite direction) from the longitudinally lower leg 52, also in a direction generally parallel to the longitudinal axis 42.

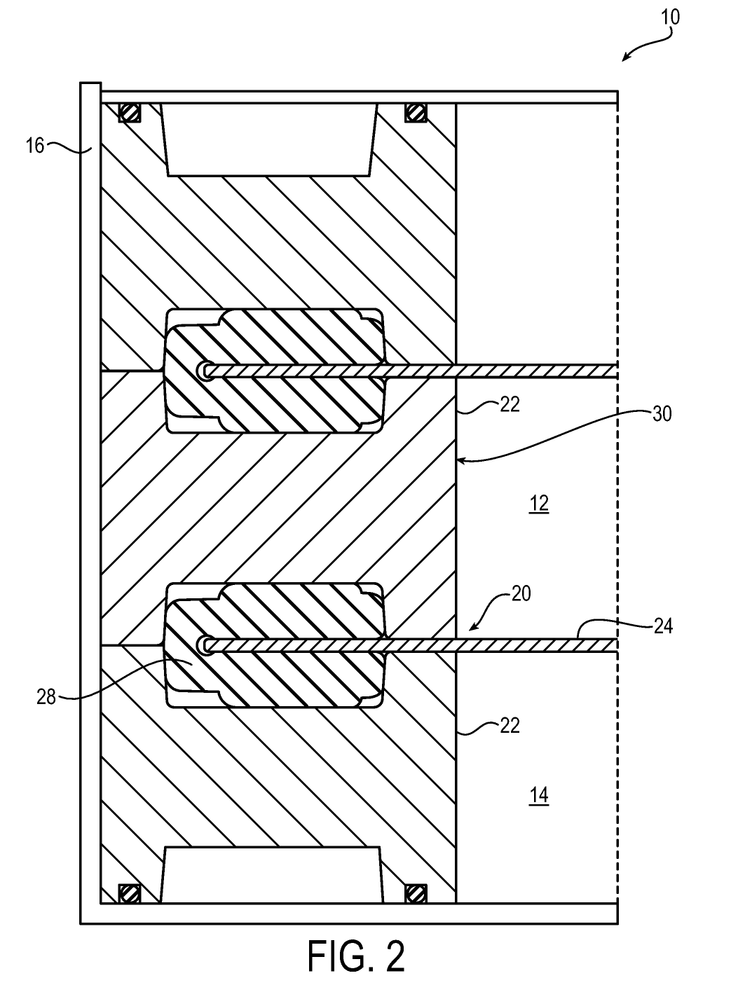

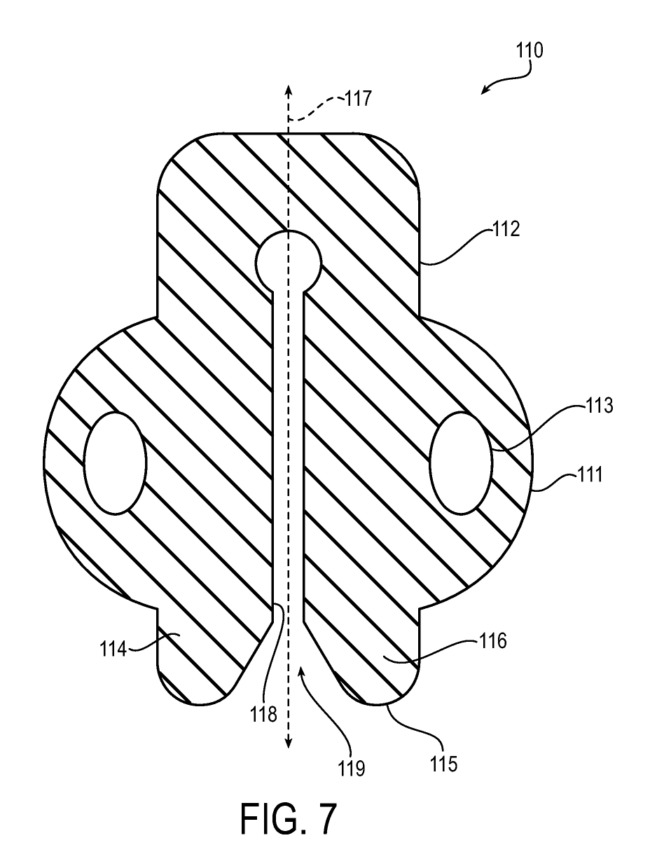

Turning now to FIG. 7, in an alternative embodiment, another annular seal 110 is shown that may be used in the power cell 10 of FIG. 2. The exemplary seal 110 shown is substantially the same as the annular seal 28 (FIG. 1), and thus the description of the seal 28 is equally applicable to the seal 110 except as noted below. Moreover, it will be appreciated upon reading and understanding the specification that aspects of the seals 28, 110 may be substituted for one another or used in conjunction with one another where applicable.

The annular seal 110 has a seal body 112 that may be configured such that opposed legs 114, 116 are biased towards one another but are not contiguous with one another along a lateral plane 117. For example, in an uncompressed state and isolated from a separation plate and frame members, the depicted opposed legs 114, 116 are spaced from one another. Thus, the illustrated seal body 112 in an uncompressed state has a slit 118 having a wider opening 119 than the opening 72 of the seal body 40 (FIG. 6).

The seal body 112 also has end portions 115 having rounded innermost extents as compared to the generally flat radially inner faces 80 of the seal body 40 (FIG. 6). Further, the seal body 112 has opposed longitudinally facing projections 111 each having an annular projection cavity 113 extending therethrough about a respective longitudinal axis. In this way, the projections 111 are generally hollow and may require less compressive force to compress the projections 111.

While the projection cavities 113 are each shown as being ovular in cross-section, other shapes, sizes, and/or locations of one or both of the cavities 113 may be suitable in other embodiments. Additionally or alternatively, one or both of the cavities 113 may be omitted, and/or one or both projections 111 may include more than one cavity extending therethrough. Each cavity 113 may extend fully or partially about the respective longitudinal axis and thus may or may not be a continuous annular cavity. While the cavities 113 are shown as closed from an external environment, a cavity 113 in other embodiments may extend to an external surface of the seal body 112, such as to the slit 118 or to an external surface of the respective projection 111.

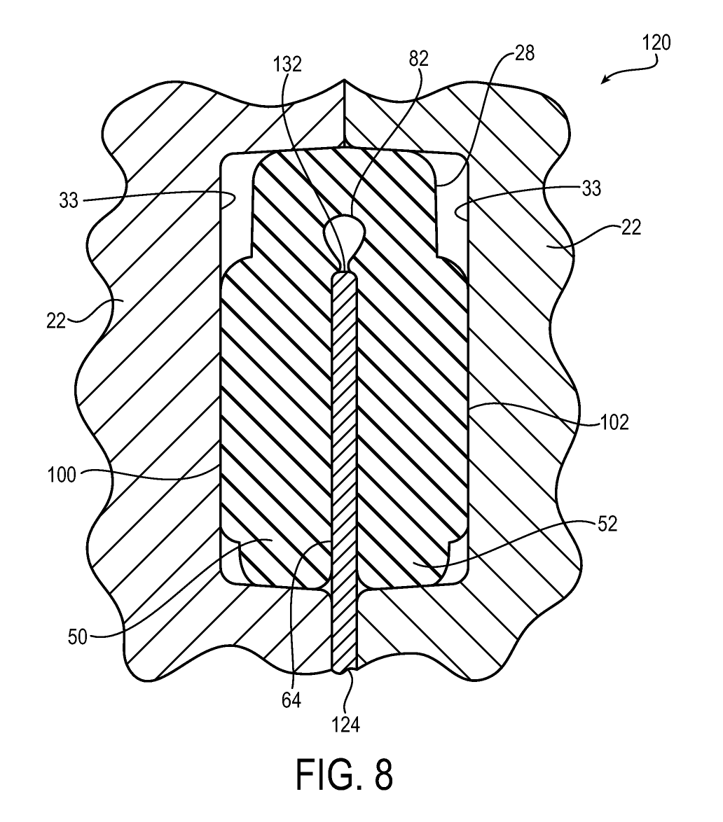

Referring next to FIG. 8, the seal 28 is shown in a compressed state in a partial view of a seal assembly 120, such as for use in the power cell 10 of FIG. 2. The sealing projections 100, 102 are in contact with the respective frame members 22. In this arrangement of the seal assembly 20, a single seal 28 is used to seal between a separation plate 124 and each of the frame members 22.

The exemplary seal assembly embodiment 120 shown is substantially the same as the seal assembly 20 (FIG. 1), and thus the description of the seal assembly 20 is equally applicable to the seal assembly 120 except as noted below. Moreover, it will be appreciated upon reading and understanding the specification that aspects of the seal assemblies 20, 120 may be substituted for one another or used in conjunction with one another where applicable.

The seal 28 in the seal assembly 120 has been wrapped about the separation plate 124. The outer perimeter edge 132 of the separation plate 124 has been received within the slit 64 of the seal body 40, and the legs 50, 52 are wrapped about the separation plate 124. The separation plate 124 is sized such that it does not extend into the annular cavity 82, though the separation plate 124 may be sized to further be received into the annular cavity 82 in other embodiments, such as with the separation plate 24 shown in FIGS. 1 and 2 in the seal assembly 20.

The seal 28 and separation plate 124 sub-assembly has been placed between the frame members 22 such that the seal 28 is retained in the channels 33 of the frame members 22. The frame members 22 have been brought towards one another such that opposite axial sides of the seal 28 are compressed between the separation plate 124 and the respective frame member 22. A central portion of the separation plate 124 is interposed between and in contact with the frame members 22, covering the respective central openings. The projections 100, 102 are compressed against and in contact with the channels 33.

In summary, exemplary embodiments of the present invention include an annular seal assembly 20, 120, to seal a chamber 12, 14 of a power cell 10. The annular seal assembly 20, 120 includes opposed mating members 22, a separation plate 24, 124 covering an opening 30 of one of the mating members 22, and an annular seal 28, 110 for sealing about the separation plate 24, 124 and between the separation plate 24, 124 and each of the adjacent mating members 22. An exemplary annular seal 28, 110 includes a seal body 40, 112 that is disposed about a longitudinal axis 42 and is configured to receive an outer perimeter edge 32 of the separation plate 24, 124 into a slit 64, 118 of the seal body 40, 112. The seal 28, 110 in an uncompressed state isolated from the separation plate 24, 124 and the mating members 22 includes opposed axial faces 60, 62 of the slit 64, 118 being biased towards one another. The seal 28, 110 includes bulbous sealing projections 100, 102 disposed at opposite axial sides of the slit 64, 118 that are compressible to seal between the separation plate 24, 124 and the mating members 22.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. An annular seal comprising:
an annular seal body formed of an elastomeric material and configured for being compressed along a longitudinal axis of the seal body, the seal body having
a slit that opens radially inwardly towards the longitudinal axis and into a central opening through the seal, the slit extending about the central opening,
a pair of opposed longitudinally facing sealing projections disposed at opposite sides of the seal body across the slit and extending about the central opening for being compressed when located within a seal retainer, and
a U-shaped connecting portion located radially outwardly of the longitudinally facing sealing projections and defining an internal cavity extending about the longitudinal axis,
wherein the slit extends radially outwardly of the longitudinally facing sealing projections to the internal cavity.

2. The annular seal of claim 1, wherein the U-shaped connecting portion has a longitudinally facing upper face and a longitudinally facing lower face disposed opposite one another and extending parallel to one another.

3. The annular seal of claim 1, wherein the U-shaped connecting portion has longitudinally facing upper and lower faces that extend radially outwardly from the pair of opposed longitudinally facing sealing projections in a direction orthogonal to the longitudinal axis.

4. The annular seal of claim 1, wherein the longitudinally facing sealing projections each are spaced a same distance radially inwardly from a radially outermost extent of the seal body.

5. The annular seal of claim 1, wherein the seal body has a U-shaped cross-section taken in a direction from the longitudinal axis radially outwardly to a radially outermost extent of the seal body.

6. The annular seal of claim 1, wherein the seal body includes a pair of radially inwardly extending legs defining the slit therebetween.

7. The annular seal of claim 1, wherein the slit extends radially along a lateral plane disposed orthogonal to the longitudinal axis of the seal body.

8. The annular seal of claim 1, wherein the seal body includes longitudinally opposed beveled ends angled radially inwardly towards one another to define an opening for the slit.

9. The annular seal of claim 1, wherein the slit separates the seal body into a longitudinally-upper portion and a longitudinally-lower portion that are radially outwardly connected to one another at the U-shaped connecting portion.

10. The annular seal of claim 1, wherein the seal body is configured such that the seal body is biased towards a closed position of the slit when the seal is isolated in an uncompressed state.

11. The annular seal of claim 1, wherein the seal is a static seal.

12. A sealing assembly comprising the annular seal of claim 1 and a separation plate, wherein an outer perimeter edge of the separation plate is received into the slit such that the annular seal is disposed fully about the outer perimeter edge of the separation plate.

13. An annular seal for sealing about a separation plate disposed between mating members of chambers of a chambered device, the seal comprising:
a seal body having
a longitudinal axis and extending annularly about the longitudinal axis and about a central opening of the seal body,
a pair of opposed legs extending radially inwardly toward the central opening,
a pair of bulbous sealing projections longitudinally projecting in opposite directions from a respective leg of the pair of opposed legs for contact with respective opposed mating members of the chambered device, and
a U-shaped connecting portion connecting radially outward extents of the pair of opposed legs, the connecting portion defining therein an annular internal cavity extending about the longitudinal axis and disposed radially outwardly of the sealing projections,
wherein the seal body extends radially along a radial length between the radially-outwardly located U-shaped connecting portion and radially-inwardly projecting distal ends of the pair of opposed legs, with the legs longitudinally separable from one another across the radial length for receipt of the separation plate therebetween into the seal body.

14. The annular seal of claim 13, wherein the pair of bulbous sealing portions are offset radially inwardly from a midpoint along the radial extent.

15. The annular seal of claim 13, wherein each leg of the pair of opposed legs includes a longitudinally-inwardly directed face, and wherein the seal isolated in an uncompressed state includes the legs biased longitudinally inwardly towards one another.

16. The annular seal of claim 15, wherein the internal cavity has a longitudinally upper wall of the cavity and a longitudinally lower wall of the cavity, and wherein the seal body is configured to maintain separation of the upper wall and the lower wall from one another when the seal is in a compressed state.

17. The annular seal of claim 13 in combination with the separation plate, wherein an outer perimeter edge of the separation plate is received into the slit such that the annular seal is disposed fully about the outer perimeter edge of the separation plate.

18. A chambered power cell, comprising:
a power cell body; and
a seal assembly disposed within the power cell body for sealing between adjacent chambers of the power cell, the seal assembly including
opposed retainer members each having an opening,
a separation plate disposed between the opposed retainer members and covering the openings of the retainer members, and
an annular seal retained in opposed cavities of the opposed retainer members, the seal having a U-shaped cross-section and a seal body disposed about a longitudinal axis that is configured to receive an outer perimeter edge of the separation plate into a slit of the seal body such that the seal is disposed fully about the separation plate,
wherein the seal includes opposed axial walls of the slit being biased towards one another, and a pair of opposed, bulbous sealing projections disposed at opposite axial sides of the slit and being compressible to seal between the separation plate and each of the opposed frame members of the power cell to separate environments of the adjacent chambers of the power cell from one another.

19. The chambered power cell of claim 18, wherein the annular seal includes a radially-inwardly angled lead-in at a radially innermost extent of the seal to receive the separation plate therebetween.

20. The chambered power cell of claim 18, wherein the slit of the annular seal extends radially outwardly to an annular cavity disposed within the seal radially outwardly of the bulbous sealing projections.
